(19) United States
(12) Patent Application Publication
(10) Pub. No.: US 2026/0113380 A1
(43) Pub. Date: Apr. 23, 2026

(54) SYSTEMS AND METHODS FOR MANAGING NETWORK SESSIONS WITH MACHINE-LEARNING SYSTEMS

(71) Applicant: DK Crown Holdings Inc., Boston, MA (US)

(72) Inventors: Robin Mohseni, Billericay (GB); Gengyuan Zhang, Boston, MA (US); Gregory Von Pless, Melrose, MA (US)

(73) Assignee: DK Crown Holdings Inc., Boston, MA (US)

(21) Appl. No.: 19/358,919

(22) Filed: Oct. 15, 2025

Related U.S. Application Data
(60) Provisional application No. 63/708,492, filed on Oct. 17, 2024.
(60) Provisional application No. 63/708,554, filed on Oct. 17, 2024.
(60) Provisional application No. 63/708,504, filed on Oct. 17, 2024.
(60) Provisional application No. 63/708,509, filed on Oct. 17, 2024.
(60) Provisional application No. 63/708,542, filed on Oct. 17, 2024.
(60) Provisional application No. 63/708,528, filed on Oct. 17, 2024.
(60) Provisional application No. 63/711,415, filed on Oct. 24, 2024.
(60) Provisional application No. 63/719,406, filed on Nov. 12, 2024.
(60) Provisional application No. 63/741,297, filed on Jan. 2, 2025.
(60) Provisional application No. 63/741,671, filed on Jan. 3, 2025.

(51) Int. Cl. H04L 67/141; G06F 40/30

(52) U.S. Cl. CPC H04L 67/141; G06F 40/30

(57) ABSTRACT

Systems and methods for managing network sessions with machine-learning systems are disclosed. A system can initiate a communication session with a client device. The communication session can correspond to a language model. The system can receive a prompt for the language model from the client device during the communication session. The system can determine, prior to providing the prompt as input to the language model, that an intent of the prompt fails to satisfy at least one criterion for the communication session. The system, responsive to determining that the intent of the prompt fails to satisfy the at least one criterion, can provide a message to the client device indicating that the prompt fails to satisfy the at least one criterion, and can restrict the prompt from being provided as input to the language model during the communication session.

### CROSS-REFERENCES TO RELATED APPLICATIONS

This application claims the benefit of and priority to U.S. Provisional Patent Application Ser. No. 63/741,297 , filed Jan. 2, 2025; and claims the benefit of and priority to U.S. Provisional Patent Application Ser. No. 63/708,509 , filed Oct. 17, 2024; and claims the benefit of and priority to U.S. Provisional Patent Application Ser. No. 63/708,492 , filed Oct. 17, 2024; and claims the benefit of and priority to U.S. Provisional Patent Application Ser. No. 63/708,528 , filed Oct. 17, 2024; and claims the benefit of and priority to U.S. Provisional Patent Application Ser. No. 63/708,542, filed Oct. 17, 2024; and claims the benefit of and priority to U.S. Provisional Patent Application Ser. No. 63/708,504 , filed Oct. 17, 2024; and claims the benefit of and priority to U.S. Provisional Patent Application Ser. No. 63/711,415 , filed Oct. 24, 2024; and claims the benefit of and priority to U.S. Provisional Patent Application Ser. No. 63/708,554 , filed Oct. 17, 2024; and claims the benefit of and priority to U.S. Provisional Patent Application Ser. No. 63/719,406 , filed Nov. 12, 2024; and claims the benefit of and priority to U.S. Provisional Patent Application Ser. No. 63/741,671, filed Jan. 3, 2025; the contents of each of which are incorporated herein by reference in their entireties for all purposes.

### BACKGROUND

Network environments can support communication between multiple computing devices using techniques such as packet-switching. Data transmitted between devices can be synchronized such that multiple devices on the same network access the same information. However, it can be challenging to efficiently synchronize data transmission for graphical elements using conventional networking technology.

### SUMMARY

At least one other aspect of the present disclosure is directed to a system. The system can include one or more processors coupled to a non-transitory memory. The system can initiate a communication session with a client device. The communication session can correspond to a language model. The system can receive a prompt for the language model from the client device during the communication session. The system can determine, prior to providing the prompt as input to the language model, that an intent of the prompt fails to satisfy at least one criterion for the communication session. The system can, responsive to determining that the intent of the prompt fails to satisfy the at least one criterion, provide a message to the client device indicating that the prompt fails to satisfy the at least one criterion. The system can, responsive to determining that the intent of the prompt fails to satisfy the at least one criterion, restrict the prompt from being provided as input to the language model during the communication session.

In some implementations, the system can terminate the communication session with the client device. The system can determine the intent of the prompt by providing the prompt as input to a second language model with an instruction to determine the intent of the prompt. The system can determine the intent of the prompt using a machine-learning model different from the language model. The system can restrict initiation of a second communication session in response to receiving a request from the client device.

In some implementations, the system can determine, based on the prompt, a restriction duration for initiation of further communication sessions. The system can restrict the initiation of the second communication session during the restriction duration. The communication session can correspond to a set of session intents. The system can determine that the intent of the prompt fails to satisfy the at least one criterion for the communication session responsive to the intent of the prompt not being included in the set of session intents. The system can determine that the intent of the prompt fails to satisfy the at least one criterion for the communication session responsive to the intent of the prompt matching a restricted intent for the communication session.

In some implementations, the prompt can be a second prompt. The system can receive a first prompt during the communication session prior to the second prompt. The system can determine that the intent of the first prompt satisfies the at least one criterion for the communication session. The system can provide the first prompt as input to the language model to generate an output message for the communication session responsive to the first prompt. The system can determine that the client device has transmitted a predetermined number of prompts that fail to satisfy the at least one criterion for the communication session. The system can terminate the communication session with the client device responsive to determining that the client device has transmitted the predetermined number of prompts.

At least one aspect of the present disclosure relates to a method. The method can be performed, for example, by one or more processors coupled to a non-transitory memory. The method can include initiating, by one or more processors coupled to non-transitory memory, a communication session with a client device, the communication session corresponding to a language model. The method can include receiving a prompt for the language model from the client device during the communication session. The method can include determining prior to providing the prompt as input to the language model, that an intent of the prompt fails to satisfy at least one criterion for the communication session. The method, responsive to determining that the intent of the prompt fails to satisfy the at least one criterion, can include providing a message to the client device indicating that the prompt fails to satisfy the at least one criterion. The method, responsive to determining that the intent of the prompt fails to satisfy the at least one criterion, can include restricting the prompt from being provided as input to the language model during the communication session.

In some implementations, the method can include terminating the communication session with the client device. The method can include determining the intent of the prompt by providing the prompt as input to a second language model with an instruction to determine the intent of the prompt. The method can include determining the intent of the prompt using a machine-learning model different from the language model. The method can include restricting initiation of a second communication session in response to receiving a request from the client device.

In some implementations, the method can include determining, based on the prompt, a restriction duration for initiation of further communication sessions. The method can include restricting the initiation of the second communication session during the restriction duration. The communication session can correspond to a set of session intents. The method can include determining that the intent of the prompt fails to satisfy the at least one criterion for the communication session responsive to the intent of the prompt not being included in the set of session intents. The method can include determining that the intent of the prompt fails to satisfy the at least one criterion for the communication session responsive to the intent of the prompt matching a restricted intent for the communication session.

In some implementations, the prompt can be a second prompt. The method can include receiving a first prompt during the communication session prior to the second prompt. The method can include determining that the intent of the first prompt satisfies the at least one criterion for the communication session. The method can include providing the first prompt as input to the language model to generate an output message for the communication session responsive to the first prompt. The method can include determining that the client device has transmitted a predetermined number of prompts that fail to satisfy the at least one criterion for the communication session. The method can include terminating the communication session with the client device responsive to determining that the client device has transmitted the predetermined number of prompts.

These and other aspects and implementations are discussed in detail below. The foregoing information and the following detailed description include illustrative examples of various aspects and implementations and provide an overview or framework for understanding the nature and character of the claimed aspects and implementations. The drawings provide illustration and a further understanding of the various aspects and implementations and are incorporated into and constitute a part of this specification. Aspects can be combined, and it will be readily appreciated that features described in the context of one aspect of the invention can be combined with other aspects. Aspects can be implemented in any convenient form, for example, by appropriate computer programs, which may be carried on appropriate carrier media (computer readable media), which may be tangible carrier media (e.g., disks) or intangible carrier media (e.g., communications signals). Aspects may also be implemented using any suitable apparatus, which may take the form of programmable computers running computer programs arranged to implement the aspect. As used in the specification and in the claims, the singular forms of ‘a,’ ‘an,’ and ‘the’ include plural referents unless the context clearly dictates otherwise.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 illustrates a block diagram of an example data processing system for managing network sessions with a machine learning system, in accordance with one or more implementations;

FIGS. 2A-2B illustrate example user interfaces of a communication session on a client device, in accordance with one or more implementations;

FIG. 3 illustrates an example flow diagram of a method of restricting data from being input to a language model, in accordance with one or more implementations; and

FIG. 4 is a block diagram of an example computing environment, in accordance with one or more implementations.

### DETAILED DESCRIPTION

Below are detailed descriptions of various concepts related to, and implementations of, techniques, approaches, methods, apparatuses, and systems for parameter search and adjustment. The various concepts introduced above and discussed in greater detail below may be implemented in numerous ways, as the described concepts are not limited to any particular manner of implementation. Examples of specific implementations and applications are provided primarily for illustrative purposes.

Natural language processing techniques can be applied across a wide range of computing environments to generate responses or other outputs based on natural language prompts. Language models and other machine-learning models can be used in various applications, including but not limited real-time information retrieval interfaces, which can be limited according to processing capacity of the systems executing such machine-learning models. To perform such operations, a language model can process input data sequences that represent prompts, contextual information, and other relevant data.

As language models typically include a large number of parameters, invoking such language models typically requires significant processing resources that make language models challenging to use for certain applications (e.g., real-time or near real-time applications. The number of operations and the amount of memory used to process a prompt is generally influenced by the size of the input context provided to the language model. Input contexts can include historical exchanges, metadata, and/or external reference information that may be relevant to generating an accurate or contextually suitable output. Generating suitable outputs typically involves providing large amounts of information as input to language models, which can significantly hinder performance, both in terms of accuracy and execution performance (e.g., computing resource utilization).

Conventional techniques for supplying input contexts to language models fail to ameliorate these issues. For example, conventional approaches often require sending large contexts, which often include an entire accumulated input, across multiple requests to achieve a requested output. Increasing the size of the input context results in increased network latency and bandwidth consumption. During output generation, executing language models with large input contexts causes processor load and increased memory allocation that grow at rates that reduce the feasibility of using language model in many real-time or near real-time applications. As a result, existing systems experience limited throughput, excessive memory consumption, and elevated network resource usage.

The techniques described herein address these and other issues by generating targeted input contexts for a language model that include only data determined to be relevant to a given prompt. In general, the techniques can select prompt-specific subsets of available context data based on one or more classification processes and/or rule-based policies. By constructing an input context from only the selected subset, the techniques described herein can significantly reduce the processing resources needed to process the input context without omitting information that is pertinent to generating an accurate output. Such context selection operations can be perform in connection with session-based data persistence, such that follow-on prompts can be processed according to previously stored interaction data, in some implementations.

By selectively reducing the contents of an input context based on prompt relevance and by avoiding redundant transmission of static context data, the techniques described herein can lower processing time and memory requirements for language model execution. Network bandwidth consumption can also be reduced because only incremental or newly relevant data is transmitted for follow-on prompts, rather than the entire accumulated context. These improvements can provide faster response times for multi-turn interactions, sustain throughput in high-load scenarios, and enable the use of large-scale language models within low-latency applications where conventional approaches would exceed performance constraints.

In further detail, various implementations of the systems and methods described herein can be used to reduce processor utilization and memory consumption when processing prompts with additional contextual input via one or more language models or other machine-learning models. For example, a system can maintain one or more data structures storing specific information that can be automatically selected for inclusion in an input context of the language/machine-learning models. As noted above, the computing resources (e.g., computing time and/or memory/caching consumption) used to execute language models or other natural language processing functions on computers increase at least quadratically with the size of the input context (e.g., the input data to be processed). Executing language models using existing techniques therefore restricts the context size according to the expected/target processing time of a corresponding request. For real-time or near real-time applications, such extended delays make using language models impossible to use.

To address these challenges, the systems and methods described herein can dynamically generate an input context that includes a subset of data that can be used to carry out requested computing operations. Such automatic selection may be performed, for example, according to intent classification operations executed using additional machine-learning models and/or specific rules-based selection policies. By automatically selecting certain data to be included in the input context, the systems and methods described herein automatically limit the input context for the language model to a targeted subset of available data, thereby reducing the latency (e.g., processing time) and memory allocation required to carry out the requested operations using the language model. As a result, the systems and methods described herein operate more efficiently, and allow for the use of language models in real-time or near real-time processing applications, which would otherwise be impossible to implement using existing techniques.

The systems and methods disclosed herein provide a technical solution to managing and controlling interactions between users and language models during communication sessions by evaluating an intent behind user prompts and applying predefined criteria. The systems and methods can determine inappropriate or irrelevant user prompts to prevent misuse of the language model. Unregulated use of language models can lead to unintended or inappropriate outputs (e.g., when intent behind a prompt does not align with the desired or permissible use cases). Language models can result in outputs that are irrelevant, harmful, or otherwise undesirable during a communication session. Moreover, certain prompts may be provided in order to compromise the security of language models or the systems that execute language models. Generally, processing such unrelated prompts both exposes the computing system executing the language model to potentially malicious prompts, and can consume computational resources while occupying network bandwidth that could otherwise be used to serve legitimate inputs.

The systems and methods described herein provide a technical solution to manage and control the interaction between users and language models during communication sessions by evaluating an intent behind user prompts and applying predefined criteria. To do so, the techniques implementing prompt classification operations during each stage of the communication session to determine whether the intent of the prompt aligns with one or more suitable intent classifications. An intent classification process can be executed using either a machine-learning classifier or a rules-based evaluator to generate a classification for the prompt. If the classification matches one of a set of restricted categories, a restriction operation can be triggered. The restriction operation can include preventing transmission of the prompt to the large language model, returning a pre-generated notice to the user that the prompt is outside the permitted domain, and/or terminating the communication session entirely.

By performing this classification and restriction in real-time, the system can prevent the processing of prompts associated with unintended purposes while a session is active. Doing so can improve the security of language model systems that would otherwise execute malicious prompts. As a result, the systems that implement the techniques described herein operate more efficiently by reducing the amount of processing resources that are dedicated to processing malicious or restricted inputs.

In various implementations, the technical solutions described herein can address the challenge of hallucinations in LLM outputs, where the model generates responses that are plausible but incorrect. For example, by generating improved input contexts with particular data from up-to-date data sources using structured input, the systems and methods described herein can reduce the likelihood of hallucinatory responses from the LLM. Some implementations described herein can perform additional training and fine-tuning processes that update LLMs to adapt to new data and correct any inaccuracies in their responses. Unlike conventional approaches, which fail to produce accurate and consistent LLM output, the techniques described herein can process data for LLMs to reduce instances of hallucinations and increase output precision and accuracy.

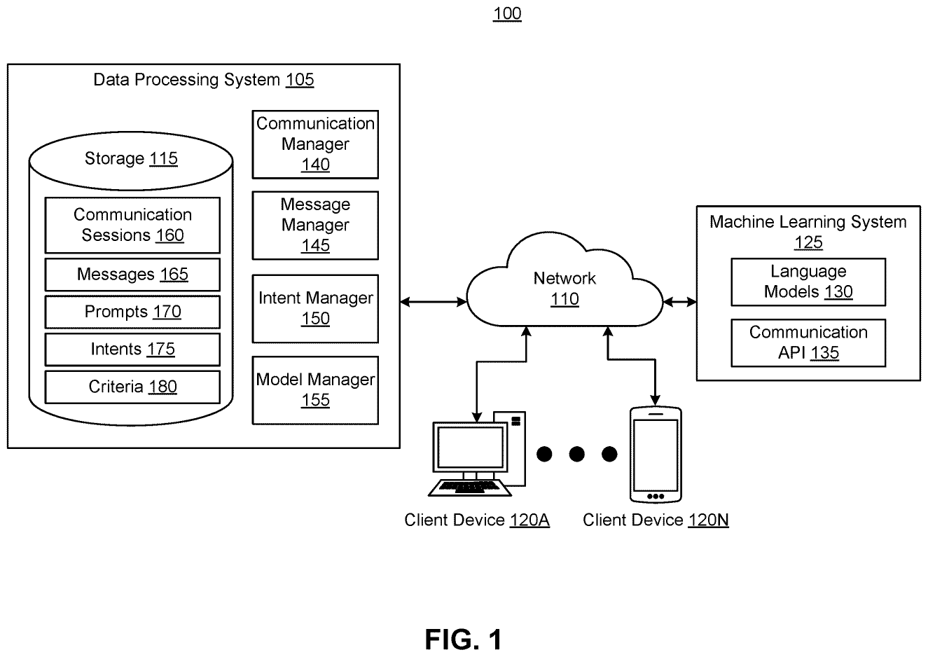

Referring now to FIG. 1, illustrated is a block diagram of an example system 100 for managing network sessions with machine-learning systems, in accordance with one or more implementations. The system 100 can include at least one data processing system 105, one or more client devices 120A-120N (sometimes generally referred to in the singular or the plural as “client device(s) 120”) and a machine learning system 125. The data processing system 105 can be a server system, a cloud-computing platform, a local computing system, a node in a distributed network, a desktop computer, a client device, or any other system that can process information. The data processing system 105 can be or include one or multiple computing nodes, servers, or distributed processing systems. The data processing system 105 can include a communication manager 140, a message manager 145, an intent manager 150, a model manager 155, and at least one storage 115. The storage 115 can include one or more communication sessions 160, messages 165, prompts 170, intents 175, or criteria 180. Although shown here as internal to the data processing system 105, the storage 115 can be external to the data processing system 105, for example, as a part of a cloud computing system or an external computing device in communication with the devices (e.g., the data processing system 105, the client device 120, etc.) of the system 100 via the network 110.

Each of the components (e.g., the communication manager 140, the message manager 145, the intent manager 150, the model manager 155, and the storage 115, etc.) of the system 100 can be implemented using the hardware components or a combination of software with the hardware components of a computing system, such as any other computing system described herein. Each of the components (e.g., the communication manager 140, the message manager 145, the intent manager 150, the model manager 155, and the storage 115, etc.) can be implemented on a single data processing system 105 or implemented on multiple, separate data processing systems 105. Although various processes are described herein as being performed by the data processing system 105, it should be understood that said operations or techniques may also be performed by other computing devices (e.g., one or more client devices 120, models of the machine learning system 125, etc.), either individually or via communications with the data processing system 105. Each of the components of the data processing system 105 can perform the functionalities detailed herein.

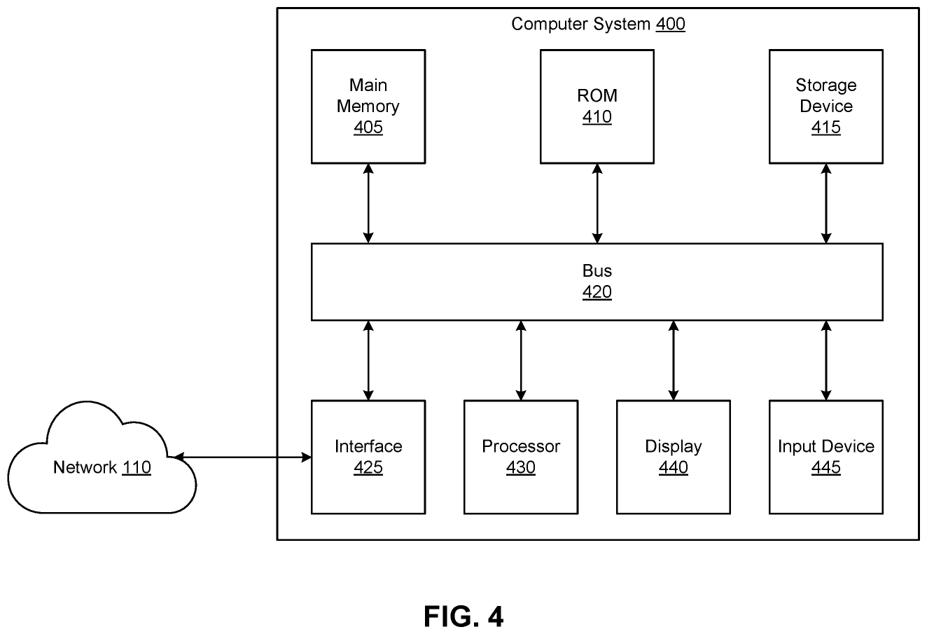

The data processing system 105 can include at least one processor and a memory (e.g., a processing circuit). The memory can store processor-executable instructions that, when executed by a processor, cause the processor to perform one or more of the operations described herein. The processor may include a microprocessor, an application-specific integrated circuit (ASIC), a field-programmable gate array (FPGA), a graphics processing unit (GPU), a tensor processing unit (TPU), etc., or combinations thereof. The memory may include, but is not limited to, electronic, optical, magnetic, or any other storage or transmission device capable of providing the processor with program instructions. The memory may further include a floppy disk, CD-ROM, DVD, magnetic disk, memory chip, ASIC, FPGA, read-only memory (ROM), random-access memory (RAM), electrically erasable programmable ROM (EEPROM), erasable programmable ROM (EPROM), flash memory, optical media, or any other suitable memory from which the processor can read instructions. The instructions may include code from any suitable computer programming language. The data processing system 105 can include one or more computing devices or servers that can perform various functions as described herein. The data processing system 105 can include any or all the components and perform any or all the functions of the computer system 400 described in connection with FIG. 4.

In some implementations, the data processing system 105 may communicate with the client device 120, for example, to receive, transmit, or process data, via the network 110. In one example, the data processing system 105 can be or can include an application server or webserver, which may include software modules allowing various computing devices (e.g., the client device 120, etc.) to access or manipulate data stored by the data processing system 105.

The network 110 can include computer networks such as the Internet, local, wide, metro or other area networks, intranets, satellite networks, other computer networks, such as mobile phone (voice or data) communication networks, or combinations thereof. The data processing system 105 of the system 100 can communicate via the network 110 with one or more computing devices, such as the one or more client devices 120. The network 110 may be any form of computer network that can relay information between the data processing system 105, the one or more client devices 120, the machine learning system 125, and one or more information sources, such as web servers or external databases, amongst others. In some implementations, the network 110 may include the Internet and/or other types of data networks, such as a local area network (LAN), a wide area network (WAN), a cellular network, a satellite network, or other types of data networks. The network 110 may also include any number of computing devices (e.g., computers, servers, routers, network switches, etc.) that are configured to receive or transmit data within the network 110.

The network 110 may further include any number of hardwired or wireless connections. Any or all of the computing devices described herein (e.g., the data processing system 105, the one or more client devices 120, the computer system 100, etc.) may communicate wirelessly (e.g., via Wi-Fi, cellular communication, radio, etc.) with a transceiver that is hardwired (e.g., via a fiber optic cable, a CAT5 cable, etc.) to other computing devices in the network 110. Any or all of the computing devices described herein (e.g., the data processing system 105, the one or more client devices 120, the computer system 100, etc.) may also communicate wirelessly with the computing devices of the network 110 via a proxy device (e.g., a router, network switch, or gateway).

The client device 120 can include at least one processor and a memory (e.g., a processing circuit). The memory can store processor-executable instructions that, when executed by the processor, cause the processor to perform one or more of the operations described herein. The processor can include a microprocessor, an ASIC, an FPGA, a GPU, a TPU, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language. The client device 120 can include at least one computing device or server that can perform various operations as described herein.

Each client device 120 can be a personal computer, a laptop computer, a television device, a smart phone device, a mobile device, or another type of computing device. Each client device 120 can be implemented using hardware or a combination of software and hardware. Each client device 120 can include a display or display portion. The display can include a display portion of a television, a display portion of a computing device, or another type of interactive display (e.g., a touchscreen, etc.). Each client device 120 may include one or more I/O devices (e.g., a mouse, a keyboard, digital keypad, buttons, trackpads, touch sensor of the touchscreen, etc.). The display can include a touch screen displaying an application, such as a web browser application or a native application, which may be used to access the functionality of the data processing system 105, as described herein.

A client device 120 can receive interactions from a user (sometimes referred to herein as a “player”). The client device 120 may also receive interactions via any other type of I/O device. The interactions can result in interaction data, which can be stored and transmitted by the processing circuitry of the client device 120. The interaction data can include, for example, interaction coordinates, an interaction type (e.g., drag, click, swipe, scroll, tap, etc.), and an indication of an actionable object (e.g., an interactive user-interface element, such as a button, hyperlink, etc.) with which the interaction occurred. The interaction data can identify a user-interface element with which the interaction occurred.

The client device 120 can be a smartphone device, a mobile device, a personal computer, a laptop computer, a television device, a broadcast receiver device (e.g., a set-top box, a cable box, a satellite receiver box, etc.), or another type of computing device. The client device 120 can be implemented hardware or a combination of software and hardware. The client device 120 can include a display or display portion. The display can include a touchscreen display, a display portion of a television, a display portion of a computing device, a monitor, a GUI, or another type of interactive display (e.g., a touchscreen, a graphical interface, etc.) and one or more I/O devices (e.g., a touchscreen, a mouse, a keyboard, digital key pad). The client device 120 can include or be identified by a device identifier, which can be specific to each respective client device 120. The device identifier can include a script, code, label, or marker that identifies a particular client device 120. In some implementations, the device identifier can include a string or plurality of numbers, letters, characters, or any combination numbers, letters, and characters. In some embodiments, each client device 120 can have a unique device identifier.

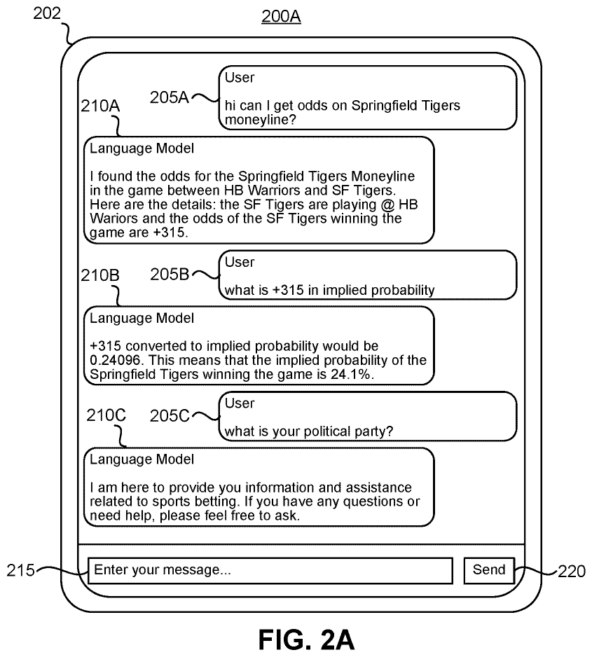

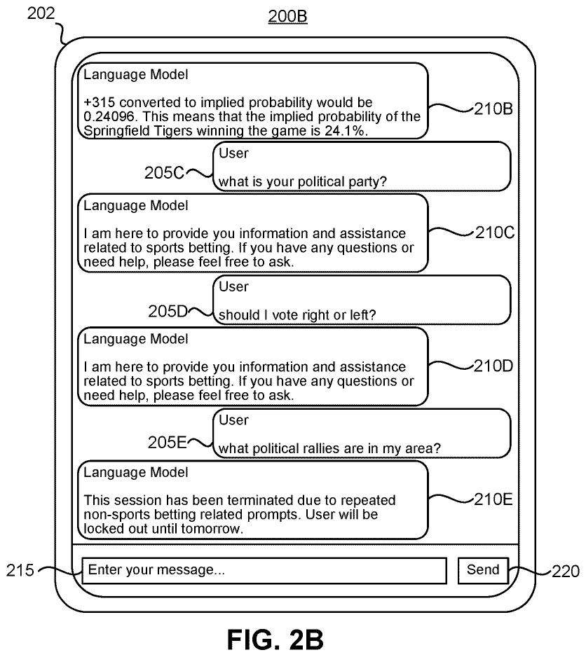

Each client device 120 can include a client application. The client application can be or include a web browser or a local application that communicates with the data processing system 105. The client application can include and/or present graphical user interfaces (e.g., the user interfaces described in connection with FIGS. 2A-2B, etc.). The graphical user interfaces may be referred to as application interfaces. The client application can initiate and/or terminate communication sessions 160. The client application can input prompts 170 into one or more communication sessions 160 and generate one or more data records. The client application can display a history of prompts 170 and messages 165 within one or more communication sessions 160. In some embodiments, the client application can display a message 165 indicating that a prompt 170 was determined to have an intent 175 that fails to satisfy at least one criterion 180. The client application can display an indication or message 165 that a communication session 160 has been terminated. The client application can present an indication or message 165 that a restriction duration persists, preventing the initiation of a communication session 160. The client application can include a web application, a server application, a resource, a desktop, or a file. Other functionalities described herein may also be provided by the client application.

The client application can include a local application (e.g., local to a client device 120), hosted application, a SaaS application, a virtual application, a mobile application, or other forms of content. In some implementations, the client application can include or correspond to applications provided by remote servers or third-party servers. In some implementations, the client application can access the communication session 160, the messages 165, the prompts 170, the intents 175, or the criteria 180 stored and maintained in the storage 115. The application may generate or otherwise present one or more graphical user interfaces (e.g., interactive user-interface elements). The graphical user interfaces can include user-selectable hyperlinks, buttons, graphics, videos, images, or other interactive elements to control the functionality of the application make corresponding requests to the data processing system 105 to perform any of the techniques described herein. Interactions with such interactive user-interface elements (sometimes referred to as “actionable objects”) can cause the client application executing on the respective client device 120 to generate a signal, which can cause the client application to perform further operations corresponding to the actionable object.

In some implementations, the client devices 120 can establish one or more communication sessions 160 with the data processing system 105. The communication session 160 can include a channel or connection between the data processing system 105 and a client device 120. The communication sessions 160 can each include an application session (e.g., virtual application), an execution session, a desktop session, a hosted desktop session, a terminal services session, a browser session, a remote desktop session, a URL session or a remote application session. Each communication session 160 can include encrypted or secure sessions, which can include encrypted files, data, or traffic. The communication sessions 160 can be interactive sessions, allowing the users to input prompts 170 and then displaying messages 165. The prompts 170 can be in the form of questions, commands, or requests for information. The data processing system 105 processes the prompts 170 and generates messages 165 that are displayed to the user in the communication session 160 via graphical user interfaces.

In some implementations, the graphical user interface can present prompts 170 and messages 165 within the communication session 160. For example, the graphical user interface can display a message 165 on the odds of a bet or wager in response to a prompt 170 from a client device 120. The client application can be executing on each client device 120 and may be provided to the client device 120 by the data processing system 105 or via an application distribution platform. The graphical user interface can allow users to input prompts 170 related to sports betting, such as requests for odds for upcoming games, the likelihood of a particular team winning a match, or the potential payout for various types of bets (e.g., moneyline, point spread, or over/under). For example, if a user submits a prompt 170 asking for the latest odds on a football game, the client application can present a message 165 that displays the updated moneyline odds, showing which team is favored to win and by how much.

In some implementations, in response to interactions with graphical user interfaces, the client device 120, via the client application and/or the network 110, can send (e.g., transmit) and/or receive information (e.g., data) to the data processing system 105. The data transmitted can include information about prompts 170 (e.g., questions or text input by the users, wager amounts, selections to request information about a status of a contest, etc.). The data transmitted can include communication session 160 information (e.g., status of communication session 160, the number of opened communication sessions 160, number of interactions, number of prompts 170 etc.).

The machine learning system 125 can include one or more language models 130 and one or more communication application programming interfaces (API) 135. The machine learning system 125 can include any type of computing system that can execute one or more machine learning models, which may include the language model(s) 130 and/or any other machine learning models described herein. The machine learning system 125 can include one or more machine learning models trained on various datasets, including but not limited to datasets for large language models. The machine learning system 125 can include a cloud system, one or more servers, a distributed remote system, or any combination thereof. The machine learning system 125 can include processing components that include, but are not limited to, one or more central processing units (CPUs), one or more graphics processing unit (GPUs), tensor processing units (TPUs), or the like. The machine learning system 125 can include a memory operable to store one or more instructions for operating components of the machine learning system 125 and operating components operably coupled to the machine learning system 125. For example, the instructions can include firmware, software, hardware, operating systems, or embedded operating systems, among others.

In some implementations, the machine learning system 125 can be internal to the data processing system 105. For example, although shown as separate from the data processing system 105, in some implementations the machine-learning system 125 (or the functionality thereof) may be implemented as part of the data processing system. In some implementations, the machine learning system 125 can be external to the data processing system 105 and can be accessed via the network 110, for example, using one or more API keys or authentication processes to process input contexts and/or prompts 170 from the data processing system 105. In some implementations, the machine learning system 125 implement or otherwise provide access to one or more application programming interfaces (APIs), via which the data processing system 105 and/or the client system 115 can access the language model 190 or other functionality of the machine learning system 125.

The language models 130 of the machine learning system 125 can include any artificial intelligence, machine learning, or deep learning models for understanding and generating human language. The language models 130 can include natural language processing (NLP) models such as large language models. The language model 130 can be trained on text data. For instance, the language models 130 can be trained/updated/fine-tuned to perform a variety of text processing tasks, including, but not limited to, generating text, formatting instructions 165, comprehending and processing natural language input, and responding to queries with contextually relevant information.

The language model 130 can include a transformer architecture, such as a generative pre-trained transformer (GPT) architecture. The transformer architecture can include an encoder that can process the input text and a decoder that can generate the output text. The language model 130 can include multiple layers that can operate to process and generate text. For example, embedding layers can convert words or tokens into dense vectors of fixed size, attention layers can use mechanisms such as self-attention to weigh the importance of different tokens in a sequence, and feedforward layers can apply transformations to the data to learn complex patterns. In some implementations, the language model 130 can use a self-attention mechanism to weight different parts of the input sequence when generating predictions. The language model 130 may be pre-trained (and in some implementations fine-tuned, updated, or re-trained) using large corpuses of natural language text data, such that the language model 130 can efficiently process and provide output corresponding to natural language input.

Natural language input can have a syntactic structure in which individual words, collections of words (e.g., phrases), or relative positions of words (e.g., word order) can indicate specific meanings. The language model 130 can be trained/updated/fine-tuned to parse sentences into their grammatical components to understand the structure and relationships between words. The language model 130 can use phrasing structure rules that define how words combine to form phrases and sentences. The language model 130 can receive an input context, which can include a sequence of tokens and/or text data structured in a format compatible with an input layer of the language model 130. In some implementations, the language model 130 may include or may be associated with a tokenizer model, which can convert a text-based or media-based input context into a sequence of tokens compatible with an input layer of the language model 130. The input context may include natural language, structured data, or combinations thereof, and may specify instructions for the model to generate particular output (e.g., formatting instructions 165, etc.) according to the techniques described herein. The language model 130 can receive an input context generated by the data processing system 105 based on one or more intents 175 determined based on the intent classifier 150.

As described herein, the input context can include relevant wager opportunities 160 identified based on the prompt. The data processing system 105 can transmit the input context to the language model 130. The machine learning system 120 can execute the language model 130 to process the input context. The language model 130 can generate an output data structure including one or more tokens representing an output message generated based on the input context. In some implementations, tokens or combinations of tokens can indicate special control data for the language model, including but not limited to the beginning of prompts/natural language text, or the beginning/end of wager opportunities, deep links, or other types of media modalities, among others.

The communication API 135 of the machine learning system 125 can facilitate interaction between the one or more language models 130 and the data processing system 105. For example, the communication API 135 can receive prompts and/or input contexts provided by the data processing system 105 using prompts 170 from a client device 120 (e.g., text queries, commands, or other forms of input). For example, the communication API 135 can receive input data from a model manager 155. Input data from a model manager 155 can include requests to allow or restrict other input data from being passed on to a language model 130, or requests to allow or restrict responses generated by a language model 130 from being output to a data processing system 105 or client device 120. The communication API 135 can forward the parsed input to a language model 130 for processing. The communication API 135 can retrieve a response generated by a language model 130 after the language model 130 has processed an input. The communication API 135 can format a response generated by a language model 130 into a suitable structure (e.g., JSON, XML) that can be easily understood and utilized by other applications. A communication API 135 can utilize authentication mechanisms (e.g., API keys, OAuth tokens) to verify the identify of a requesting identity to ensure secure communication.

In some implementations, the storage 115 can be a computer-readable memory that can store or maintain any of the information described herein. The storage 115 can store or maintain one or more data structures, which may contain, index, or otherwise store each of the values, pluralities, sets, variables, vectors, numbers, or thresholds described herein. The storage 115 can be accessed using one or more memory addresses, index values, or identifiers of any item, structure, or region maintained in the storage 115. The storage 115 can be accessed by the components of the data processing system 105, or any other computing device described herein, via the network 110. In some implementations, the storage 115 can be internal to the data processing system 105. In some implementations, the storage 115 can exist external to the data processing system 105 and may be accessible via the network 110. The storage 115 can be distributed across many different computer systems or storage elements, and may be accessed via the network 110 or a suitable computer bus interface. The data processing system 105 can store, in one or more regions of the memory of the data processing system 105 or in the storage 115, the results of any or all computations, determinations, selections, identifications, generations, constructions, or calculations in one or more data structures indexed or identified with appropriate values.

Any or all values stored in the storage 115 may be accessed by any computing device described herein, such as the data processing system 105, to perform any of the functionalities or functions described herein. In some implementations, a computing device, such as a client device 120, may utilize authentication information (e.g., username, password, email, etc.) to show that the client device 120 is authorized to access requested information in the storage 115. The storage 115 may include permission settings that indicate which users, devices, or profiles are authorized to access certain information stored in the storage 115. In some implementations, instead of being internal to the data processing system 105, the storage 115 can form a part of a cloud computing system. In such implementations, the storage 115 can be a distributed storage medium in a cloud computing system and can be accessed by any of the components of the data processing system 105, by the one or more client devices 120 (e.g., via one or more user interfaces, etc.), or any other computing devices described herein.

The storage 115 can store or otherwise maintain one or more communication sessions 160, for example, in one or more data structures. A communication session may include a record of one or conversations or communications with a client device 120, and can include a one or more prompts 170 and messages 165. A communication session 160 can be updated in response to receiving a prompt 170 or a message 165, for example, from a client device 120 or a language model 130, respectively. A communication session 160 can be initiated or terminated by a request from the client device 120 or the data processing system 105. In some embodiments, the initiation of subsequent communication session 160 can be restricted for certain players based on one or more flags defined in one or more player profiles of different players. In some embodiments, the initiation, updates, and/or termination of a communication session 160 is managed by the communication manager 140. In some embodiments, a communication session 160 can be terminated in response to a determination by the intent manager 150 that a prompt fails to satisfy at least one criterion 180. In some embodiments, a communication session 160 can be initiated in response to a determination by the intent manager that a prompt satisfies at least one criterion 180. In some implementations, a communication session 160 can be initiated in response to a determination by the intent manager that a prompt satisfies multiple criteria 180.

A communication session 160 can enable a user to interact with one or more language models 130, for example, a communication session 160 can be displayed visually on a client device 120. A communication session 160 displayed on a client device 120 (e.g., via graphical user interface) can display one or more data records. For example, a communication session 160 displayed on a client device 120 can display a plurality of prompts 170 transmitted from a client device 120 and a plurality of messages 165 transmitted from a machine learning system 125 in response to one or more prompts 170.

The storage 115 can store or otherwise maintain one or more messages 165 in one or more data structures. Each message 165 can be generated by one or more language models 130 and transmitted via one or more communication APIs 135 to the data processing system 105 (or any components thereof). A message 165 may be an output message generated by the language model 130 based on an input context that includes a prompt 170. The message 165 may include text data, such as letters, characters, or any combination of numbers, letters, and characters. For example, when a prompt 170 and/or supplemented input context is received, the language model 130 can processes the input context and generates a message 165 that contains relevant data or information as a response. In an implementation where the language model 130 is used to determine whether a prompt 170 satisfies one or more criteria 180 (e.g., whether the prompt itself should be used in connection with a corresponding communication session 160), an output message 165 can indicate that the prompt 170 has been determined to have an intent 175 that fails to satisfy at least one criterion 180. Messages 165 provided during a communication session 160 can be provided for display on a client device 120, for example, while the client device 120 engaging in a communication session 160. In another example, a message 165 can be displayed on a client device 120, after a communication session 160 has been terminated (e.g., as a historical record of the communication session 160).

The storage 115 can store or otherwise maintain one or more prompts 170 in one or more data structures. A prompt 170 can be transmitted by a client device 120 in response to one or more interactions with an application executing on the client device 120. A prompt 170 can include text data from various sources, including a string or plurality of numbers, letters, characters, or any combination of numbers, letters, and characters. A prompt 170 can include data in one or more data structures. For example, a prompt 170 can include data of one or more intents 175. Upon receiving prompt 170 from one or more client devices 120, the prompt 170 can be stored in association with the corresponding communication session 160 to which it corresponds. Prompts 170 transmitted by client devices 120 can be displayed on a client device 120, for example, during the communication session 160 to which it corresponds. In another example, a prompt 170 can be displayed on a client device 120, after a communication session 160 has been terminated, as a presentation of a record of the communication session 160.

In some implementations, the prompt 170 can be a string of text, such as a question, command, or statement, that the player provides via interaction(s) at the client device 120 or client application to communicate with the data processing system 105 during a communication session 160. For example, a prompt 170 can include, “what are the odds for today's football game?”. The prompt 170 can include numerical input, such as a request that include calculations or comparisons. The prompt 170 can be a request to perform an action, such as initiating a process, retrieving data, identifying wager recommendations, identifying application interfaces and/or webpages, generating any other information as output. The user can input a prompt 170 asking to “generate a report of all the football game scores of games played this week”. The prompt 170 can include follow-up texts to a previous interaction, where the user continues an ongoing conversation with the language model 130 (e.g., the prompt can include “Can you provide more details?”).

The storage 115 can store or otherwise maintain one or more intents 175 in one or more data structures. An intent 175 can be generated the data processing system 105 or by a language model 130. For example, an intent 175 can be generated by an intent manager 150. An intent 175 can be generated in response to a determination by a language model 130. An intent 175 can be a corresponding prompt 170 or set of prompts 170 transmitted during a communication session 160. For example, a prompt 170 can have an intent 175 associated with a request for wagers, which may include a wager for particular sport(s), live event(s), team(s), participant(s), wager type(s), or any other intent information. The intent 175 may be a request for information, a request to update wager opportunities, player profile information, bet slips, or any other information described herein. In some implementations, the intent 175 may be an intent that fails to satisfy one or more criteria 180 for a communication session 160, such as intents directed to opinions, dangerous requests or dangerous output, or requests/inquiries relating to entities, concepts, or other data that are not to be communicated during communication sessions 160 according to the criteria 180.

The data processing system 105 and/or the language model 130 within the machine learning system 125 can generate the intent 175 and store the intent 175 in the storage 115 (e.g., an intent manager 150) for further use. The intent 175 can be determined from factors within the communication sessions 160, such as the content of prompts 170, and in some implementations further based on one or more messages 165 and/or input contexts that are intended to be provided to the language model 130 for processing. An intent 175 can be determined or derived from a prompt 170, the content of a message 165 or prompt 170, the length of the message 165 or prompt 170, the number of messages 165 or prompts 170, or the number of a subset of messages 165 or prompts 170 within a communication session 160, among other factors.

In some implementations, the language model 130 can be used to determine the intent 175 for a prompt 170 (or for multiple prompts 170 or message(s) 165 during a communication session 160). For example, the language models 130 can be executed using the prompt and additional instructions to perform sentiment analysis on text data of the prompt 170. The language models 130 can classify the tone of the text data of the prompt 170. Sentiment analysis can include binary classification to label text as either positive or negative based on the patterns learned from the text data. The language models 130 can include multiple sentiment levels, classifying the intent 175 into more than two categories (e.g., strongly positive, positive, neutral, negative, or strongly negative). The language models 130 can include multi-class classification techniques to handle a broader range of sentiment labels, which may correspond to respective concepts, entities, or information specified in the criteria 180.

In some implementations, the intent 175 can be classified using supervised and/or unsupervised machine learning techniques. In some implementations, in a supervised machine learning approach, the data processing system 105 and/or the machine learning system 125 can execute one or more machine learning models that are trained on labeled data to associate user prompts 170 (or portions thereof) with predefined classifications of intents 175. Trained data can include acceptable prompts 170 that lead to acceptable intents 175, and unacceptable prompts that lead to unacceptable intents (e.g., patterns of trolling or spamming behavior have been labeled in training data). For example, in a sports client application, acceptable intents may be related to sports, such as checking scores, placing bets, or requesting team statistics, while unacceptable intents include discussions about politics, trolling behavior, discussions about illegal activity (e.g., creating explosives), or inappropriate language. Unsupervised learning techniques, such as clustering, can allow the data processing system 105 the machine learning system 125 to identify new or emerging patterns in user behavior without labeled data.

In some implementations, the language models 130 and/or the machine learning system 125 can implement additional or alternative NLP techniques to determine or extract intents 175 from prompts 170. For example, additional machine learning models including transformers, recurrent neural networks (RNNs), named entity recognition (NER), and sentiment analysis models may be used to generate classification(s) of intents 175 for one or more prompts 170. The NLP techniques can be used to process and analyze the text of a prompt 170 to determine the intent 175. NLP techniques can include breaking down a prompt 170 into multiple phrases or segments based on word choice, sentence structure, and context.

In one example, tokenization can be used to break down a prompt 170 into individual words or phrases, which can be processed by the language model 130 or other machine learning models to implement syntactic and semantic analysis and to determine an intent 175. The language models 130, via NLP techniques, can determine the intent 175 across multiple prompts 170 within the same communication session 160. For example, if a user submits multiple prompts 170 about sports betting odds, the data processing system 105 can determine an intent 175 related to sports betting even if keywords are not repeated in every prompt 170. The use of NLP techniques can enhance the ability of the data processing system 105 to interpret complex prompts 170, ensuring that intents 175 are accurately determined.

Intent 175 can be determined based on the actions of the user, such as repetitive prompts 170 or patterns of behavior within a communication session 160. If a user repeatedly inputs the same or similar prompts 170, the data processing system 105 and/or a language model 130 within the machine learning system 125 can associate an intent 175 with the repetitive behavior, indicating that the user may be submitting potentially unacceptable or unsafe prompts 170. This type of intent 175 can be determined from the frequency, pattern, or volume of identical or near-identical prompts 170.

In some implementations, other types of language models (e.g., secondary language models) that are trained/updated to classify an intent of a prompt may be executed (e.g., by the intent manager 150) to classify the intent 175 for a prompt 170. The data processing system 105 can determine the intent 175 of a prompt 170 by providing the prompt 170 as input to a secondary language model. In one example, the secondary language model may be a transformer-based model (e.g., Bidirectional Encoder Representations from Transformers (BERT), another type of language model, etc.). The secondary language models may include fewer parameters than the language model 130, and may be trained/updated to classify intents 175 from natural language input rather than provide/generate general natural language output. For example, if the user submits the prompt 170, “What are the odds for Team A tonight?”, the secondary language model can analyze the prompt 170 and classify the intent 175 as a request for odds information of one or more wagers for “Team A”. If the prompt 170 is “Who are you supporting during the presidential elections?”, the second language model 130 can classify that the intent 175 as including trolling or malicious behavior. In certain embodiments, the data processing system 105 can determine the intent 175 of a prompt 170 using a machine-learning model other than a language models. For example, the data processing system 105 can use a classification model (e.g., a neural network, any other type of classifier) trained to identify spamming attempts or other types of malicious prompts 170.

The intent may be classified using the secondary language model because the first language model 130 can be more resource-intensive, or may potentially result in unintended output. For example, as the language model 130 is trained/updated to generate general, natural language output rather than strictly generating intent classifications, certain input prompts (e.g., jailbreak prompts) may result in the language model 130 generating output that is unintended or unsafe. The separation of tasks between the language model 130 and secondary language model can improve efficiency and resource allocation of the machine learning system 125 and/or the data processing system 105. The separation of tasks between the first language models and second language models can allow the machine learning system 125 to handle a larger number of communication sessions 160 simultaneously without exhausting computing resources, improving the processing capabilities of each system.

When an intent 175 is classified, the data processing system 105 can determine the appropriate action to be taken based on the intent 175 and whether the intent 175 satisfies criteria 180 stored in the storage 115. Actions performed if the (restricting further input from the user, terminating the communication session 160, or flagging the behavior for moderation). The storage 115 can store or otherwise maintain one or more criteria 180 in one or more data structures. Criteria can be associated with an intent 175, a message 165 or a prompt 170, the content of a message 165 or prompt 170, the length of the message 165 or prompt 170, the number of messages 165 or prompts 170, or the number of a subset of messages 165 or prompts 170 within a communication session. For example, a criterion can require a certain string of text to be present in a prompt 170 or message 165 to be satisfied. In another example, a criterion may be satisfied by a predetermined number of prompts being input from a client device. A criterion 180 can be sent or received by one or more language models 130, by one or more communication APIs 135, by one or more processors within a data processing system 105, or by an input from an operator of the data processing system 105.

A criterion 180 can be used to evaluate the intents 175 of prompts 170 to determine whether the prompts 170 are to be processed using the language model 130. To do so, the data processing system 105 can compare the intent 175 to one or more criteria 180. The criteria 180 may include a predetermined set of intents 175 that may be communicated using a prompt 170 during a communication session 160. For example, a criterion 180, if satisfied by one or more intents 175, can result the data processing system 105 providing a prompt 170 within an input context for processing by the language model 130 to perform various actions. In another example, if the prompt 170 fails to satisfy any criteria 180, a signal can be sent to the model manager 150 indicating that the corresponding prompt(s) 175 are to be restricted from being provided as input to the language model 130, due to failure to satisfy the criterion 180.

Criteria 180 can be associated with any number or combinations of intents 175. For example, criteria 180 can represent a category of intents 175 corresponding to prompts 170 or messages 165 that are permissible to be passed on to a language model 130. In another example, one or more criteria 180 may represent a category of intents 175 corresponding to prompts 170 or messages 165 that should be restricted from being passed on to a language model 130. In one embodiment, criteria 180 can represent a category of intents 175 corresponding to harmful or malicious conduct towards the system that require a communication session 160 to be terminated. For example, termination of a communication session 160 can result when a criterion 180 is satisfied by one or more prompts 170, as described in further detail herein.

In some implementations, the criteria 180 can be a rule or condition that is used by the data processing system 105 evaluate the intent 175 for a prompt 170. The data processing system 105 can compares the intent 175 to the criterion 180 to determine if the intent satisfies the required conditions. For example, certain intents 175 may be permissible (e.g., requesting sports scores), while others, such as discussing politics in a sports-related platform, are not allowed. If the intent 175 derived from the prompt 170 does not match an acceptable category of intents 175, the criterion 180 is not satisfied, and the data processing system 105 can take further actions (e.g., provide a message 165 to the client device 120 indicating that the prompt 170 fails to satisfy the at least one criterion 180, restrict the prompt 170 from being provided as input to the language model 130 during the communication session 160, terminate the communication session 160 with the client device 120, etc.).

When an intent 175 fails to satisfy a criterion 180, the data processing system 105 may perform any number of actions, including but not limited to restricting, or allowing, a prompt 170 from which the intent 175 was classified from being passed on to a language model 130, generating an output message (e.g., sending a message to a client device 120 that a prompt 170 or message 165 associated with the intent 175 fails to satisfy one or more criteria 180), adding to a counter that tracks the number of prompts 170 that have intents 175 that failed to satisfy at least one criterion 180, terminating a communication session 160, or determining a restriction duration for initiation of further communication sessions 160, among other actions.

Criteria 180 can be given weights. Varying weights among criteria 180 is useful in that it allows certain criteria 180 to be valued more greatly than others. Criteria 180 can be arranged in a structure such that satisfying a first criterion 180 and a second criterion 180, if triggered, the first criterion 180 associated with a first output and the second criterion 180 associated with a second output, can result in the first and second output both resulting, neither resulting, or one output resulting but not the other, according to respective weights applied to them. For example, if an intent 175 satisfies a first and second criterion 180, where the first criterion 180, if satisfied, would lead to differing result from the second criterion 180, if satisfied, and the first criterion 180 is associated with a greater weight than the second criterion 180, a processor can determine that an output associated with the first criterion 180 being satisfied should result and an output associated with the second criterion 180 being satisfied should not result.

Referring now to the operations of the data processing system 105, the communication manager 140 can initiate a communication session 160 with one or more client devices 120. The communication session 160 can be a conversation record involving prompts 170 transmitted by a client device 120 associated with a player profile and messages 165 generated by one or more language models 130. A communication manager 140 can initiate a communication session 160 in response to a request from a client device 120. The request may be transmitted, for example, upon accessing a particular application interface of an application executing on the client device 120.

The communication manager 140 can terminate a communication session 160 with one or more client devices 120. In some embodiments, a communication manager 140 can terminate a communication session 160 with a client device 120 in response to a determination that a prompt 170 has an intent 175 that satisfies at least one criterion 180. A communication session 160 can also be terminated by a communication manager 140 in response to a determination that a client device 120 has transmitted a predetermined number of prompts 170. In some embodiments, the communication manager 140 can determine that the client device 120 has transmitted a predetermined number of prompts 170 that fail to satisfy the at least one criterion 180 for the communication session 160 and terminate the communication session 160 with the client device 120 responsive to determining that the client device 120 has transmitted the predetermined number of prompts 170.

In some embodiments, the communication manager 140 can restrict initiation of communication sessions 160 in response to receiving a request from the client device 120 identifying a player profile with a flag indicating that communication sessions are not to be initiated. In some embodiments, the communication manager 140 can determine, based on a prompt 170, a restriction duration for initiation of further communication sessions 160 and restrict the initiation of a second communication session 160 during the restriction duration. The restriction duration may be stored in association with the player profile used to provide the prompt. The restriction duration can be determined based on the prompt 170, the intent 175 of the prompt 170, or the number of prompts 170 which have been determined to have intent 175 that fails to satisfy at least one criterion 180.

The message manager 145 can receive a prompt 170 for the language model 130 from the client device 120 during the communication session 160. Upon receiving the prompt 170 for a communication session 160, the message manager 145 can store the prompt 170 in association with the communication session 160 and can provide the prompt 170 to other components of the data processing system 105 to determine an intent 175 for the prompt 170.

The message manager 145 can receive any messages 165 generated by the language model 130 in response to providing one or more prompt(s) 170 and/or input contexts to the language model 130 for processing. Messages 165 received by the message manager 145 can be stored in association with the communication session 160 to which they correspond. Messages 165 received as part of a communication session 160 can be provided for display to the client device 120 accessing the communication session 160. In some implementations, the message manager 145 can format the response messages 165 received via the communication API 135 into a suitable structure that allows it to be displayed on a client device 120 and/or stored in association with the communication session 165.

The message manager 145 can receive a restriction signal from one or more components of the data processing system 105 that indicate a prompt 170 is to be restricted from being provided to the language model 130, for example, if the prompt 170 fails to satisfy one or more criteria 180, as described herein. In such implementations, the message manager 145 can provide a predetermined message to the client device 120 of the communication session 160 that indicates the prompt 170 was not provided to the language model 130. The predetermined message may include an indication that the prompt 170 should be clarified or may indicate the criteria 180 that the prompt 170 does not satisfy (e.g., in natural language format output).

The intent manager 150 can generate an intent 175 for a prompt 170 or multiple prompt(s) 170 received via the message manager 145 during a communication session 160. The intent manager 150 can use any number of techniques described herein to classify the intent 175 of the prompt(s) 170, including the use of machine learning models, the language model 130, or rule-based techniques (e.g., regex, etc.). In some implementations, the intent manager 150 can encapsulate the prompt 170 with instructions to determine the intent 175 of the prompt 170 in an input context for the language model 130 and transmit the input context to the language model 130. The response from the language model 130 can indicate the intent 175 of the prompt 170. In some implementations, the intent manager 150 can identify and/or separate phrases such as “place bet” or “check score” to classify the intent 175 of the prompt 170. The intent manager 150 and/or the language models 130 can label words within a prompt 170 with identifiers or labels (e.g., noun, verb, adjective). The intent manager 150 can transmit the identifiers or labels to the language models 130. The identifiers or labels can assist in distinguishing between requests (e.g., “check score”) and statements (e.g., “the score is high”), and can lead to more accurate determination of intent 175.

As described herein, additional or alternative machine learning models may be used to classify the intent 175 of the prompt 170. For example, secondary language models may be used that are trained/updated to generate classification(s) of one or more predetermined intents 175 in response to receiving a prompt 170 as input. The secondary language models may include fewer parameters than the language model 130, and may be trained/updated to classify intents 175 from natural language input rather than provide/generate general natural language output. The separation of tasks between the language model 130 and secondary language model can improve efficiency and resource allocation of the machine learning system 125 and/or the data processing system 105. The separation of tasks between the first language models and second language models can allow the machine learning system 125 to handle a larger number of communication sessions 160 simultaneously without exhausting computing resources, improving the processing capabilities of each system.

The intent manager 150 can compare the classified intent(s) 175 of the prompt(s) 179 to one or more criteria 180 to determine whether the prompt(s) 170 are suitable to provide to the language model 130 for direct processing (e.g., without instructions to classify an intent of the prompt, etc.). According to some embodiments, the intent manager 150 can determine, prior to providing the prompt 70 as input to a language model 130, that an intent 175 of the prompt 70 fails to satisfy at least one criterion 180 for the communication session 160. For example, the intent manager 150 can prevent prompts 170 requesting information unrelated to sports betting from being input to a language model 130.

The intent manager 150 can provide a variety of outputs to the component(s) of the data processing system 105. In some embodiments, a determination that an intent 175 fails to satisfy at least one criterion 180 can be sent to the communication manager 140, which can subsequently terminate the communication session 160 for which the corresponding prompt 170 was received. In some embodiments, a determination that an intent 175 fails to satisfy at least one criterion 180 can be sent to the model manager 155 and can result in a prompt 170 associated with the intent 175 to be restricted from a language model 130.

According to some embodiments, the intent manager 150 can determine that the intent 175 of a prompt 170 fails to satisfy at least one criterion 180 for a communication session 160 responsive to the intent 175 of the prompt 170 not being included in a set of session intents 175, which includes a predetermined set of session intents 175 for a communication session 160. According to some embodiments, the intent manager 150 can determine that the intent 175 of a prompt 170 fails to satisfy at least one criterion 180 for a communication session 160 responsive to the intent 175 of the prompt 170 matching a restricted/disallowed intent 175 for the communication session 160.

The intent manager 150 can determine whether the intent 175 of a prompt 170 satisfies predefined criteria 180 before it is passed on to a language model 130 (e.g. first language model 130). The intent 175 can be compared to criteria 180, which can include rules for appropriate content or allowable intents 175. If the intent 175 fails to meet any of these conditions, the intent manager 150 can flag the prompt 170 as unsuitable and can prevents a user from using the client application. By evaluating the intent 175 of a prompt 170 (e.g., via the second language model 130) before it reaches the first language model, the intent manager 150 can ensure that only valid and relevant inputs are processed by the language model 130. The intent manager 150 can conserve computational resources and maintain integrity of the communication session 160. For example, in a sports betting session, prompts 170 about politics or containing inappropriate language that fail to meet the criteria 180 can be filtered out by the intent manager 150 (e.g., via the secondary language model(s), other intent classification approaches, etc.). The second language model(s) can prevent the language model 130 and/or the machine learning system 125 from unnecessarily expending computational resources on irrelevant prompts 170. The second language model 130 can ensure that the user adheres to the criteria 180 for the communication session 160.

The model manager 155 can restrict and allow prompts 170 to be provided to the a machine model system 125. The model manager 155 can facilitate interaction between a data processing system 105 and one or more language models 130. According to one embodiment, the model manager 155 can restrict the prompt 170 from being provided as input to the language model 130 during the communication session 160 in response to a determination that the intent 175 of the prompt 170 fails to satisfy at least one criterion 180. If the intent 175 of a prompt 170 is determined by the component(s) of the data processing system 105 to not to be a malicious, dangerous, or unallowed prompt (e.g., satisfying criteria 180, etc.), the model manager 155can provide the prompt 170 to the language model 130.

In some implementations, the model manager 155 may generate an input context for the language model 130 by retrieving various additional information relating to the intent 175 of the prompt, including but not limited to data of one or more wager opportunities, data from one or more webpages, application interfaces, or information sources, odds information for one or more wager opportunities, player profile information, historical wagering information for one or more live events, teams, live event participants, or other data, among any other information that may be processed by the language model 130. The input context may be a sequence of characters, tokens, or structured data that is to be provided as input to the language model 130. Data can be provided to the language models 130 via the communication APIs 135 of the machine learning system 125, in some implementations. Messages 165 generated by the language model 130 can be received by the model manager 155 and/or the message manager 145, as described herein, and may be provided for presentation at the client device 120 communicating via the communication session 160.

FIGS. 2A-2B illustrate example user interfaces of an application executing on a client device (e.g., a client device 120) presenting a communication session (e.g., a communication session 160). Referring to FIG. 2A in the context of the components described in connection with FIG. 1, illustrated is an example diagram 200A showing a graphical user interface 202. The graphical user interface 202 can be displayed as part of the communication session 160. The graphical user interface 202 can be displayed on the client device 120. The graphical user interface 202 can include an input field 215 that can receive input (e.g., prompt 170) from the user. The graphical user interface 202 can include a send button 220 that can initiate the transmission or sending of the input (e.g., prompt 170) from the client device to the computing system providing the communication session (e.g., the data processing system 105).

In this example, the user has provided prompts 205A-205C. The graphical user interface 202 can display, via data received from the data processing system 105, messages 210A-210C (e.g., messages 165) generated based on the prompts 205A-205C. For example, prompts 205A and 205B can be prompts 170 requesting information on wager opportunities and information relating odds information. In this example, the criteria (e.g., the criteria 180) for the communication session can specify that the intent of prompts are to correspond to sports betting, and therefore the prompts 205A and 205B satisfy the criteria for the communication session. Furthering this example, the prompt 205C is a prompt with an intent corresponding to political questions or opinions, which fails to the criteria for the communication session. In this example, the data processing system 105 has generated or selected a message 210C indicating that the prompt 205C fails to satisfy the criteria for the communication session (e.g. because the prompt 205C is about politics).

Different criteria may be applied to multiple prompts of the communication session. Referring to FIG. 2B in the context of the components/blocks in FIGS. 1 and 2A, after a prompt (e.g., prompt 205C) fails to satisfy the criteria of the communication session, additional criteria for the communication session may limit the number of irrelevant/non-compliant prompts that may be provided before terminating the communication session. In this example, the criteria may limit the number of irrelevant/non-compliant prompts to three. In this example, a second prompt 205D that fails to satisfy criteria of the communication session has been provided, causing generation of a message 210D with a reminder reminds the user that the prompt 205D fails to satisfy the criteria of the communication session. The message 210D may be a predetermined message associated with the communication session selected based on the input prompt 205D, or may be generated from a language model, in some implementations. After repeated violations (e.g., prompt 205E), the communication session 160 can be terminated with message 210E indicating an action (e.g., blocking the user from further input, etc.). In some implementations, players can be blocked/restricted from accessing further communication sessions for a restriction duration, which may be specified in the configuration settings of the data processing system, automatically determined based on rules and/or the number of restricted prompts detected from a player, or other signals.

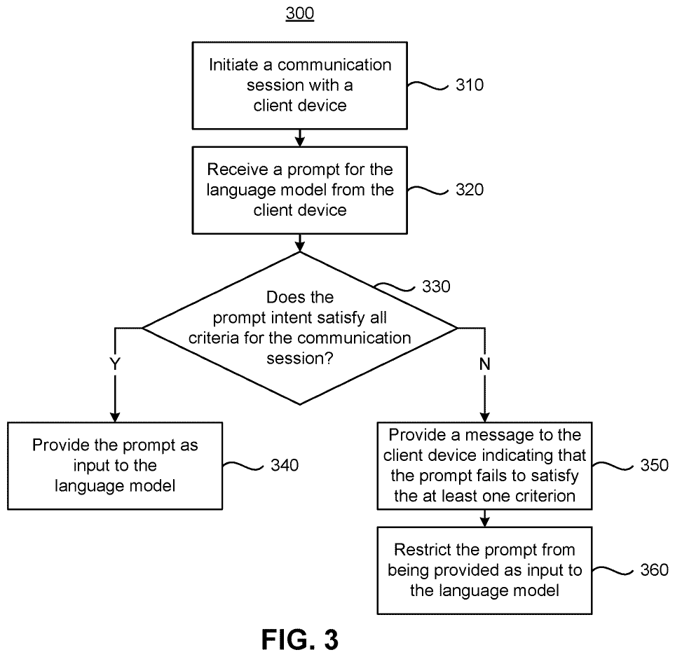

Referring to FIG. 3, illustrated is an example flow diagram of a method 300 for processing prompts in a communication session and determining whether a prompt satisfies criteria for being input into a language model, in accordance with one or more implementations. In a brief overview of the method 300, the data processing system (e.g., the data processing system 105, etc.) initiates a communication session with a client device (STEP 310), receives a prompt for the language model from the client device (STEP 320), and determines whether the prompt's intent satisfies all criteria for the communication session (STEP 330). If the prompt satisfies the criteria, the prompt is provided as input to the language model (STEP 340). If the prompt does not satisfy the criteria, the system provides a message to the client device indicating the failure (STEP 350) and restricts the prompt from being provided as input to the language model (STEP 360).

In further detail of method 300, at STEP 310, the data processing system can initiate a communication session (e.g., communication session 160) with a client device, allowing the user to begin interaction with the system. The communication session may be initiated when the user accesses an application interface of an application that communicates with the data processing system. The application can send a request to the data processing system to establish a communication session.

The request may include identifying information about the client device and the specific application initiating the connection, including an identifier of the player profile accessing functionality of the data processing system. Upon receipt of this request, the data processing system can verify the request (e.g., using authentication protocols) and allocate computing resources for the communication session. The data processing system can send an acknowledgement message back to the client device, confirming the successful initiation of the communication session (e.g., communication session 160). The application on the client device can then display a user interface that allows the user to input prompts and receive responses from the data processing system through this established communication channel.

At STEP 320, the data processing system can receive a prompt (e.g., prompt 170) from the client device. The prompt can include any query or request that the user enters via one or more graphical user interfaces. The prompt may include any type of natural language text, as described herein. This prompt can be transmitted to the data processing system through the established communication session (e.g., communication session 160). Upon receiving the prompt, the data processing system can store the prompt in association with the communication session, and proceed to STEP 330.

At STEP 330, the data processing system can determine an intent (e.g., intent 175) of the prompt. The intent can be determined by a second language model, by a classification model, using rule-based techniques or regex-based techniques, or any other type of intent classification approach. The intent can be determined prior to further processing of the prompt, and prior to providing the prompt (or an input context generated using the prompt) as input to a language model (e.g., a language model 130). The data processing system can determine whether the intent satisfies at least one or all pre-defined conditions (e.g., criteria) for the communication session. The criteria can include factors such as the intent of the prompt, length of the prompt, frequency of prompts inputted by the user, repetitiveness of prompts inputted by the user, etc. If the prompt meets the criteria, the data processing system proceeds to STEP 340. Prompts that meet the criteria can include prompts that are classified as having intents that satisfy a set of intents associated with the communication session. Otherwise, if the intent of the prompt does not satisfy one or more criteria (e.g., the prompt violates communication session rules), the data processing system proceeds to STEP 350.

At STEP 340, the prompt can be processed by a language model. The language model can generate a response based on the user prompt. In some implementations, the data processing system can generate an input context for the language model that supplements the provided prompt with additional information relating to the intent of the prompt. For example, if the prompt expresses interest in wager opportunities, the input context can be enriched with details about current betting odds, available wagers, and potential payouts for various sporting events. Similarly, if the prompt seeks odds information or information related to a specific team or live event, the input context can incorporate odds data, historical performance data, and or other information related to that team or live event. The prompt (or the input context) can then be provided to the language model for processing and response generation.

At STEP 350, the data processing system can generate a message for the client device indicating that the prompt has failed to meet at least one criteria. The message may be predetermined and selected based on the specific criterion(s) that were not satisfied. In some implementations, the data processing system can utilize the language model to generate a more contextually relevant response without necessarily providing the full user prompt to the model. The system can provide the language model with information about the failed criteria and with instructions to generate a message corresponding to the prompt.

Following STEP 350 and at STEP 360, the data processing system can restrict the prompt from being provided as input to the language model. Restricting the prompt from being provided as input to the model may include updating the player profile corresponding to the client device with an indication of the prompt. The prompt may be stored in a list of restricted prompts. In some implementations, restricting the prompt may include preventing the prompt from being included in further input contexts for the language model (e.g., omitting the prompt from the communication session). Even when omitted from the communication session, the prompt may be displayed to the user via one or more graphical user interfaces as if it were part of the communication session.

Referring to FIG. 4, an implementation of a computing system 400 is shown that can be used, for example, to implement the systems and methods described with reference to FIGS. 1, 2, and 3. The computing architecture described in FIG. 4 can be used to implement the data processing system 105, one or more of the client devices 120, or any other computing system described herein. The computing system 400 includes a bus 420 or other communication component for communicating information and a processor 430 coupled to the bus 420 for processing information. The computing system 400 also includes main memory 405, such as a random-access memory (RAM) or other dynamic storage device, coupled to the bus 420 for storing information, and instructions to be executed by the processor 430. The main memory 405 can also be used for storing position information, temporary variables, or other intermediate information during execution of instructions by the processor 430. The computing system 400 may further include a read-only memory (ROM) 410 or other static storage device coupled to the bus 420 for storing static information and instructions for the processor 430. A storage device 415, such as a solid-state device, magnetic disk, or optical disk, is coupled to the bus 420 for persistently storing information and instructions.

The computing system 400 may be coupled via the bus 420 to a display 440, such as a liquid crystal display, or active-matrix display, for displaying information to a user. The display 440 can be any type of display device, including a touchscreen device. An input device 445, such as a keyboard having alphanumeric and other keys, may be coupled to the bus 420 for communicating information, and command selections to the processor 430. The input device 445 can include a touch sensor of the touchscreen display 440. The input device 445 can include a cursor control, such as a mouse, a trackball, or cursor direction keys, for communicating direction information and command selections to the processor 430 and for controlling cursor movement on the display 440.

The computing system 400 can include an interface 425, such as a networking adapter. The interface 425 may be coupled to bus 420 and may be configured to enable communications with a computing or communications network 110 and/or other computing systems. Any type of networking configuration may be achieved using interface 425, such as wired (e.g., via Ethernet), wireless (e.g., via Wi-Fi, Bluetooth, etc.), pre-configured, ad-hoc, LAN, WAN, etc.

According to various implementations, the processes that effectuate illustrative implementations that are described herein can be achieved by the computing system 400 in response to the processor 430 executing an arrangement of instructions contained in main memory 405. Such instructions can be read into main memory 405 from another computer-readable medium, such as the storage device 415. Execution of the arrangement of instructions contained in main memory 405 causes the computing system 400 to perform the illustrative processes described herein. One or more processors in a multi-processing arrangement may also be employed to execute the instructions contained in main memory 405. In alternative implementations, hard-wired circuitry may be used in place of or in combination with software instructions to implement illustrative implementations. Thus, implementations are not limited to any specific combination of hardware circuitry and software.

Although an example processing system has been described in FIG. 4, implementations of the subject matter and the functional operations described in this specification can be carried out using other types of digital electronic circuitry, or in computer software, firmware, or hardware, including the structures disclosed in this specification and their structural equivalents, or in combinations of one or more of them.

While this specification contains many specific implementation details, these should not be construed as limitations on the scope of any inventions or of what may be claimed, but rather as descriptions of features specific to particular implementations of the systems and methods described herein. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In addition, the processes depicted in the accompanying figures do not necessarily require the particular order shown, or sequential order, to achieve desirable results.

In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. For example, the data processing system 105 could be a single module, one or more servers, part of a search engine, or, a logic device having one or more processing modules.

Having now described some illustrative implementations and implementations, it is apparent that the foregoing is illustrative and not limiting, having been presented by way of example. In particular, although many of the examples presented herein involve specific combinations of method acts or system elements, those acts and elements may be combined in other ways to accomplish the same objectives. Acts, elements, and features discussed only in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation, element, or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

Instances of “or” may be construed as inclusive so that any terms described using “or”may indicate any of a single, more than one, or all of the described terms.

Where technical features in the drawings, detailed description, or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The systems and methods described herein may be applied to other environments. The foregoing implementations are illustrative rather than limiting of the described systems and methods. The scope of the systems and methods described herein may thus be indicated by the appended claims, rather than the foregoing description, and changes that come within the meaning and range of equivalency of the claims are embraced therein.

What is claimed is:

1. A system for managing language model requests to improve computational efficiency, comprising:
one or more processors coupled to non-transitory memory, the one or more processors configured to:
initiate a communication session with a client device, the communication session corresponding to a language model;
receive a prompt for the language model from the client device during the communication session;
determine, prior to providing the prompt as input to the language model, that an intent of the prompt fails to satisfy at least one criterion for the communication session;
responsive to determining that the intent of the prompt fails to satisfy the at least one criterion:
provide a message to the client device indicating that the prompt fails to satisfy the at least one criterion; and
restrict the prompt from being provided as input to the language model during the communication session.

2. The system of claim 1, wherein the one or more processors are further configured to:
terminate the communication session with the client device.

3. The system of claim 1, wherein the one or more processors are further configured to:
determine the intent of the prompt by providing the prompt as input to a second language model with an instruction to determine the intent of the prompt.

4. The system of claim 1, wherein the one or more processors are further configured to:
determine the intent of the prompt using a machine-learning model different from the language model.

5. The system of claim 1, wherein the one or more processors are further configured to:
restrict initiation of a second communication session in response to receiving a request from the client device.

6. The system of claim 5, wherein the one or more processors are further configured to:
determine, based on the prompt, a restriction duration for initiation of further communication sessions; and
restrict the initiation of the second communication session during the restriction duration.

7. The system of claim 1, wherein the communication session corresponds to a set of session intents, and wherein the one or more processors are further configured to:
determine that the intent of the prompt fails to satisfy the at least one criterion for the communication session responsive to the intent of the prompt not being included in the set of session intents.

8. The system of claim 1, wherein the communication session corresponds to a set of session intents, and wherein the one or more processors are further configured to:
determine that the intent of the prompt fails to satisfy the at least one criterion for the communication session responsive to the intent of the prompt matching a restricted intent for the communication session.

9. The system of claim 1, wherein the prompt is a second prompt, and wherein the one or more processors are further configured to:
receive a first prompt during the communication session prior to the second prompt;
determine that the intent of the first prompt satisfies the at least one criterion for the communication session; and
provide the first prompt as input to the language model to generate an output message for the communication session responsive to the first prompt.

10. The system of claim 1, wherein the one or more processors are further configured to:
determine that the client device has transmitted a predetermined number of prompts that fail to satisfy the at least one criterion for the communication session; and
terminate the communication session with the client device responsive to determining that the client device has transmitted the predetermined number of prompts.

11. A method, comprising:
initiating, by one or more processors coupled to non-transitory memory, a communication session with a client device, the communication session corresponding to a language model;
receiving, by the one or more processors, a prompt for the language model from the client device during the communication session;
determining, by the one or more processors, prior to providing the prompt as input to the language model, that an intent of the prompt fails to satisfy at least one criterion for the communication session;
responsive to determining that the intent of the prompt fails to satisfy the at least one criterion:
providing, by the one or more processors, a message to the client device indicating that the prompt fails to satisfy the at least one criterion; and
restricting, by the one or more processors, the prompt from being provided as input to the language model during the communication session.

12. The method of claim 11, further comprising:
terminating, by the one or more processors, the communication session with the client device.

13. The method of claim 11, further comprising:
determining, by the one or more processors, the intent of the prompt by providing the prompt as input to a second language model with an instruction to determine the intent of the prompt.

14. The method of claim 11, further comprising:
determining, by the one or more processors, the intent of the prompt using a machine-learning model different from the language model.

15. The method of claim 11, further comprising:
restricting, by the one or more processors, initiation of a second communication session in response to receiving a request from the client device.

16. The method of claim 15, further comprising:
determining, by the one or more processors, based on the prompt, a restriction duration for initiation of further communication sessions; and
restricting, by the one or more processors, the initiation of the second communication session during the restriction duration.

17. The method of claim 11, wherein the communication session corresponds to a set of session intents, and further comprising:
determining, by the one or more processors, that the intent of the prompt fails to satisfy the at least one criterion for the communication session responsive to the intent of the prompt not being included in the set of session intents.

18. The method of claim 11, wherein the communication session corresponds to a set of session intents, and further comprising:
determining, by the one or more processors, that the intent of the prompt fails to satisfy the at least one criterion for the communication session responsive to the intent of the prompt matching a restricted intent for the communication session.

19. The method of claim 11, wherein the prompt is a second prompt, and further comprising:
receiving, by the one or more processors, a first prompt during the communication session prior to the second prompt;
determining, by the one or more processors, that the intent of the first prompt satisfies the at least one criterion for the communication session; and
providing, by the one or more processors, the first prompt as input to the language model to generate an output message for the communication session responsive to the first prompt.

20. The method of claim 11, further comprising:
determining, by the one or more processors, that the client device has transmitted a predetermined number of prompts that fail to satisfy the at least one criterion for the communication session; and
terminating, by the one or more processors, the communication session with the client device responsive to determining that the client device has transmitted the predetermined number of prompts.
